(19) United States
(12) Patent Application Publication
(10) Pub. No.: US 2013/0276567 A1
(43) Pub. Date: Oct. 24, 2013

(54) DRIVE UNIT

(71) Applicant: HONDA MOTOR CO., LTD., Tokyo (JP)

(72) Inventor: Masaru ODAJIMA, Wako-shi (JP)

(21) Appl. No.: 13/851,128

(22) Filed: Mar. 27, 2013

(30) Foreign Application Priority Data
Mar. 30, 2012 (JP) 2012-081074

(51) Int. Cl. F16H 57/04

(52) U.S. Cl. CPC F16H 57/043
USPC 74/421 A

(57) ABSTRACT

An object is to provide a drive unit in which a sealing structure for the motor can be simplified, and such that oil dose not leak into a motor case. The inside of the motor case is configured to be so-called dry. Although wires extending from a stator penetrate the motor case and extend to the outside, no sealing measures are required in this penetrating portion. A seal in the penetrating portion may be a simple one such as a dust seal. In other words, the present invention provides a drive unit in which the sealing structure for the motor can be simplified.

### BACKGROUND

1. Field

The present invention relates to a drive unit formed by integrating an electric motor and a reducer.

2. Description of the Related Art

In electric vehicles, a drive method is employed in which an output of an electric motor (hereafter, referred to as motor) is reduced in speed by a reducer to drive a drive wheel. A structure in which the motor and the reducer are independently disposed and a structure in which the motor and the reducer are integrated with each other are both put to practical use. Various proposals have been made for the structure in which the motor and the reducer are integrated with each other. See FIG. 7 of Patent Document 1 (Japanese Patent Application Publication No. 2006-248417), for example.

As shown in FIG. 7 of Patent Document 1, a vehicle wheel driving device (20) (The number in parentheses indicates reference numeral described in Patent Document 1. The same shall apply hereinafter.) includes an in-wheel motor (30) and a gear mechanism (50) integrated with the in-wheel motor (30). A motor shaft (36) is rotatably supported on a motor housing (31) by multiple bearings. Moreover, an output shaft supporting a large gear (52) is rotatably supported by multiple bearings (71, 72).

The bearings supporting the motor shaft (36) and the bearings (71, 72) supporting the output shaft require lubrication. Thus, in Patent Document 1, an oil guide recessed portion (43b) is provided in a gear housing chamber (43), an oil flow hole (36a) is provided in the motor shaft (36) in an axial direction thereof, and discharge holes (61a) extending in radial directions from the oil flow hole (36a) are provided. Part of oil thrown up by the large gear (52) is used to lubricate the bearings (71, 72). The rest of the oil thrown up by the large gear (52) flows through the oil guide recessed portion (43b), the oil flow hole (36a), and the discharge holes (61a) in this order, and is then discharged into the motor housing (31). The multiple bearings supporting the motor shaft (36) are thus lubricated with the discharged oil.

Incidentally, a coil portion (33) serving as a stator is housed in the motor housing (31). A rotor (34) can be rotated by supplying electric power to the coil portion (33) from the outside by using a harness.

The harness penetrates the motor housing (31). Sealing is required to prevent oil from leaking from the penetration hole. Moreover, a sealing performance needs to be maintained by interposing a sealing member between the motor housing (31) and a lid (44) for example.

In other words, in the structure of Patent Document 1, a sealing structure needs to be employed because the motor housing (31) is filled with oil drops. Accordingly, the structure of the in-wheel motor (30) becomes complex and the cost of the in-wheel motor (30) is increased.

However, the cost of the wheel drive device is desired to be reduced and there is a demand for a drive device (drive unit) in which the sealing structure for the motor can be simplified.

### SUMMARY

An object of the present invention is to provide a drive unit in which the aforementioned sealing structure for the motor can be simplified.

A first embodiment of the invention is a drive unit which includes a center case, and a motor case attached to one side surface of the center case and supporting a stator. A reducer case is attached to another side surface of the center case. A motor shaft penetrates the center case, supporting a rotor, and has one end supported by the motor case via a first bearing and another end supported by the reducer case via a second bearing. A drive gear is provided on the motor shaft and housed in the reducer case. A driven gear is rotated by a drive force of the drive gear and has one end supported by the center case via a third bearing and another end supported by the reducer case via a fourth bearing. An output shaft extends from the driven gear to penetrate the reducer case. A motor output is reduced in speed and then outputted from the output shaft; oil is held in the reducer case in such a way that part of the driven gear is immersed in the oil, a first oil pocket portion in which oil is reserved is provided between the one end of the motor shaft and the motor case, a second oil pocket portion in which oil is reserved is provided between the other end of the motor shaft and the reducer case. The first bearing and the second bearing each include a seal configured to partition a corresponding one of the pocket portions from an adjacent chamber. The reducer case is provided with an oil receiving portion configured to receive thrown-up oil in a portion surrounding the drive gear and is also provided with a communication hole through which oil reserved in the oil receiving portion flows to the second oil pocket portion, the motor shaft is provided with an in-motor-shaft oil passage through which oil reserved in the second oil pocket portion flows to the first oil pocket portion. The motor case is provided with a discharged oil passage through which oil reserved in the first oil pocket portion is discharged, and the center case is provided with a return oil passage which is connected to the discharged oil passage and through which oil from the discharged oil passage is returned into the reducer case.

A second embodiment of the invention is that the first bearing is a single seal bearing including an outer race, an inner race, a rolling body, and a sealing member sealing a space between the outer race and the inner race in a portion which is closer to the second bearing than the rolling body. The second bearing is a single seal bearing including an outer race, an inner race, a rolling body, and a sealing member sealing a space between the outer race and the inner race in a portion which is closer to the second oil pocket portion than the rolling body.

A third embodiment of the invention is such that the oil receiving portion includes a pocket-shaped arc groove formed by an arc wall which stands in the reducer case to surround the drive gear, and an opening portion configured to receive oil thrown up by the drive gear in a tangential direction is formed in an upper portion of the arc groove.

A fourth embodiment of the invention is such that the opening portion is disposed above a rotation center of the motor shaft and the communication hole is arranged below the opening portion.

A fifth embodiment of the invention is such that an inlet of the discharged oil passage is provided at a height equal to or lower than that of a rotation center of the motor shaft.

A sixth embodiment of the invention is such that a bottom surface of the center case and a bottom surface of the reducer case are arranged below a bottom surface of the motor case and the return oil passage is arranged at a height almost equal to that of the bottom surface of the motor case.

A seventh embodiment of the invention is such that the center case is provided with an oil filler into which the oil is poured.

According to certain embodiments of the invention, the motor shaft is supported by the first bearing and the second bearing while the output shaft is supported by the third bearing and the fourth bearing. The first to fourth bearings needs to be lubricated with oil.

For this reason, the first oil pocket portion is provided between the one end of the motor shaft and the motor case while the second oil pocket portion in which oil is reserved is provided between the other end of the motor shaft and the reducer case. Moreover, the motor shaft is provided with the in-motor-shaft oil passage through which the oil reserved in the second oil pocket portion flows to the first oil pocket portion, and the reducer case is provided with the oil receiving portion and the communication hole through which the oil reserved in the oil receiving portion flows to the second oil pocket portion.

The oil reserved in the reducer case is thrown up by the driven gear and part of the oil is used to lubricate the second to fourth bearings. The rest of the oil thrown up by the driven gear is received by the oil receiving portion and flows through the communication hole, the second oil pocket portion, the in-motor-shaft oil passage, and the first oil pocket portion in this order. Thereafter, the oil is used to lubricate the first bearing. The oil supplied to the second to fourth bearings is reserved in the reducer case. The oil supplied to the first bearing flows through the in-motor-shaft oil passage and the first oil pocket portion and does not leak into the motor case.

Since the inside of the motor case is dry, no hydraulic pressure is applied thereto although the motor case is sealed. Accordingly, no special measures for wet conditions are required. Hence, the sealing structure may be simple. In other words, the present invention provides a drive unit in which a sealing structure for the motor can be simplified while lubrication is thoroughly performed therein.

According to other embodiments of the invention, the first bearing includes the sealing member in the portion which is closer to the second bearing than the rolling body is. Since the sealing member is disposed on the side closer to the second bearing, the first bearing can be lubricated well with the oil reserved in the first oil pocket portion.

Moreover, the second bearing includes the sealing member in the portion which is closer to the second oil pocket portion than the rolling body. Since the sealing member is disposed on the side closer to the second oil pocket portion, the second bearing can be lubricated well with the oil thrown up by the driven gear.

In addition, the first bearing and the second bearing are each the single seal bearing including the sealing member sealing the space between the outer race and the inner race. Similar effects can be obtained also when an oil seal is attached beside the first bearing and an oil seal is disposed beside the second bearing. However, this increases the number of parts and increases the dimension in the axial direction. Hence, a compact design cannot be achieved.

In this respect, embodiments of the present invention uses the single seal bearings in which the sealing members are incorporated in the bearings. Accordingly, it is possible to reduce the number of parts and also to reduce the dimension in the axial direction.

According to certain embodiments of the invention, the oil receiving portion includes the pocket-shaped arc groove formed by the arc wall which stands in the reducer case to surround the drive gear, and the opening portion configured to receive the oil thrown up by the drive gear in the tangential direction is formed in the upper portion of the arc groove.

Accordingly, droplets of oil can be efficiently received by the oil receiving portion.

According to other embodiments of the invention, the opening portion is disposed above the rotation center of the motor shaft and the communication hole is formed below the opening portion.

Since the communication hole is provided below the rotation center, the oil reserved in the oil receiving portion can smoothly flow to the second oil pocket portion via the communication hole by the effect of gravity. As a result, flow of oil to the first oil pocket portion is promoted and lubrication of the first bearing can be improved.

According to certain embodiments of the invention, the inlet of the discharged oil passage is provided at the height equal to or lower than that of the rotation center of the motor shaft.

Since the inlet of the discharged oil passage is at the low height, the oil reserved in the first oil pocket portion can be efficiently discharged to the discharged oil passage.

According to certain embodiments of the invention, the bottom surface of the center case and the bottom surface of the reducer case are disposed below the bottom surface of the motor case, and the return oil passage is disposed at the height almost equal to that of the bottom surface of the motor case.

Since the return oil passage is at the height almost equal to that of the bottom surface of the motor case, the discharged oil passage can be extended to the bottom surface of the motor case. Specifically, the discharged oil passage extends from a portion near the rotation center of the motor shaft to the bottom surface of the motor case. Hence, the height dimension of the discharged oil passage can be increased. A so-called head (hydraulic head) is thereby increased and the oil inside the discharged oil passage can efficiently flow down and quickly return into the reducer case.

According to certain embodiments of the invention, the center case is provided with the oil filler into which the oil is poured.

Generally, a level gauge is attached to the oil filler in such a way as to be capable of being inserted and pulled out. The oil filler can be provided in any one of the center case and the reducer case.

When the oil filler including the level gauge is provided in the reducer case, the level gauge may interfere with the driven gear incorporated in the reducer case. There is such a concern that the size of the reducer case may be increased to avoid the interference.

When the oil filler is provided in the center case as in the present invention, there is no worry of the level gauge interfering with the driven gear. As a result, the reducer case can be made compact.

### BRIEF DESCRIPTION OF THE DRAWINGS

FIG. 1 is a perspective view of an electric vehicle including a drive unit according to embodiments of the present invention.

FIG. 2 is a rear view of the electric vehicle.

FIG. 3 is an enlarged view of a main portion of FIG. 2.

FIG. 4 is an exploded view around a rear wheel.

FIG. 5 is a cross-sectional view of the rear wheel and a drive unit.

FIG. 6 is an enlarged cross-sectional view of a main portion of FIG. 5.

FIG. 7 is a cross-sectional view of a main portion of each of first and second bearings.

FIG. 8 is a cross-sectional view taken along the line 8-8 of FIG. 5.

FIG. 9 is a view in the direction of the arrow 9 of FIG. 6.

FIG. 10 is a perspective view of a bearing housing portion.

FIG. 11 is a plan cross-sectional view of the bearing housing portion.

FIG. 12 is a back surface view of the drive unit.

FIG. 13 is a cross-sectional view taken along the line 13-13 of FIG. 12.

### DETAILED DESCRIPTION

Embodiments of the present invention is described below based on the accompanying drawings. Note that the drawings are to be seen in a direction in which the reference numerals can be read properly.

A drive unit according to embodiments of the present invention can be used as a drive source of an electric vehicle and a carriage as well as a drive source of an industrial machine. Although usage of the drive unit is not particularly limited, description is given below of an example where the drive unit is installed in an electric vehicle. Moreover, front, rear, left, and right are based on the perspective of a driver driving the electric vehicle.

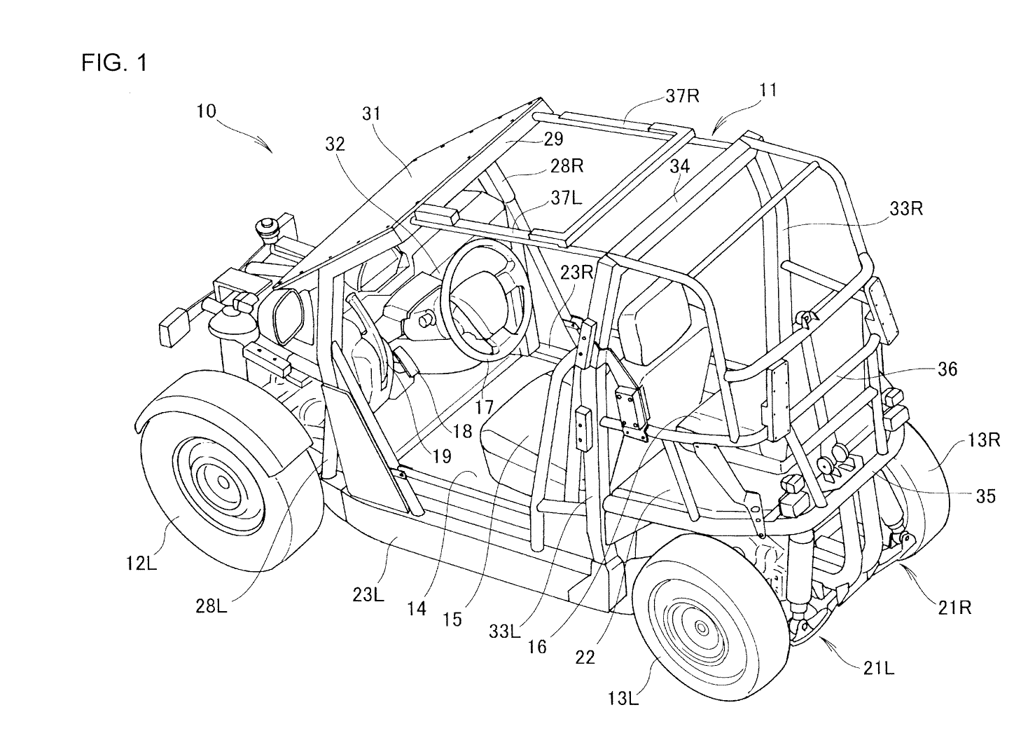

As shown in FIG. 1, an electric vehicle 10 is a narrow vehicle as follows. A vehicle body frame 11 is provided with a front wheel 12L (L is a suffix indicating left; the same shall apply hereafter) and rear wheels 13L, 13R (R is a suffix indicating right; the same shall apply hereafter). A driver seat 15 is provided on a floor 14. A passenger seat 16 is provided behind the driver seat 15. A steering wheel 17, a brake pedal 18, and a parking brake lever 19 are provided in front of the driver seat 15. Although not illustrated in FIG. 1, a right front wheel exists. In other words, the electric vehicle 10 is a narrow four-wheel vehicle.

The passenger seat 16 is disposed between the left and right rear wheels 13L, 13R and between suspension devices 21L, 21R. The passenger seat 16 may be replaced with a rear cargo bed. Alternatively, the passenger seat 16 may be detachably attached onto a rear cargo bed 22.

The vehicle body frame 11 has left and right side sills 23L, 23R as main elements.

Furthermore, front upper frames 28L, 28R extend upward respectively from front end portions of the side sills 23L, 23R and a cross sub-member 29 is laid between upper ends of the front upper frames 28L, 28R. A front shield 31 is attached to the front upper frames 28L, 28R and the cross sub-member 29 from the front.

A dashboard 32 is laid between the left and right front upper frames 28L, 28R. The steering wheel 17 is disposed slightly to the left of the vehicle width center of the dashboard 32 and the parking brake lever 19 is disposed to the left of the steering wheel 17.

Moreover, rear upper frames 33L, 33R extend upward respectively from rear end portions of the side sills 23L, 23R and a cross sub-member 34 is laid between upper ends of the rear upper frames 33L, 33R. Furthermore, a square-U shaped rear subframe 35 extends from the rear upper frames 33L, 33R at a position above the rear wheels 13L, 13R to surround the passenger seat 16 from left, right, and rear. A cage-shaped cage frame 36 extends from the rear upper frames 33L, 33R and the cross sub-member 34 to surround the passenger seat 16 at a position above the rear subframe 35. Longitudinal members 37L, 37R are laid between the front cross sub-member 29 and the rear cross sub-member 34 and a vehicle cabin is thus formed.

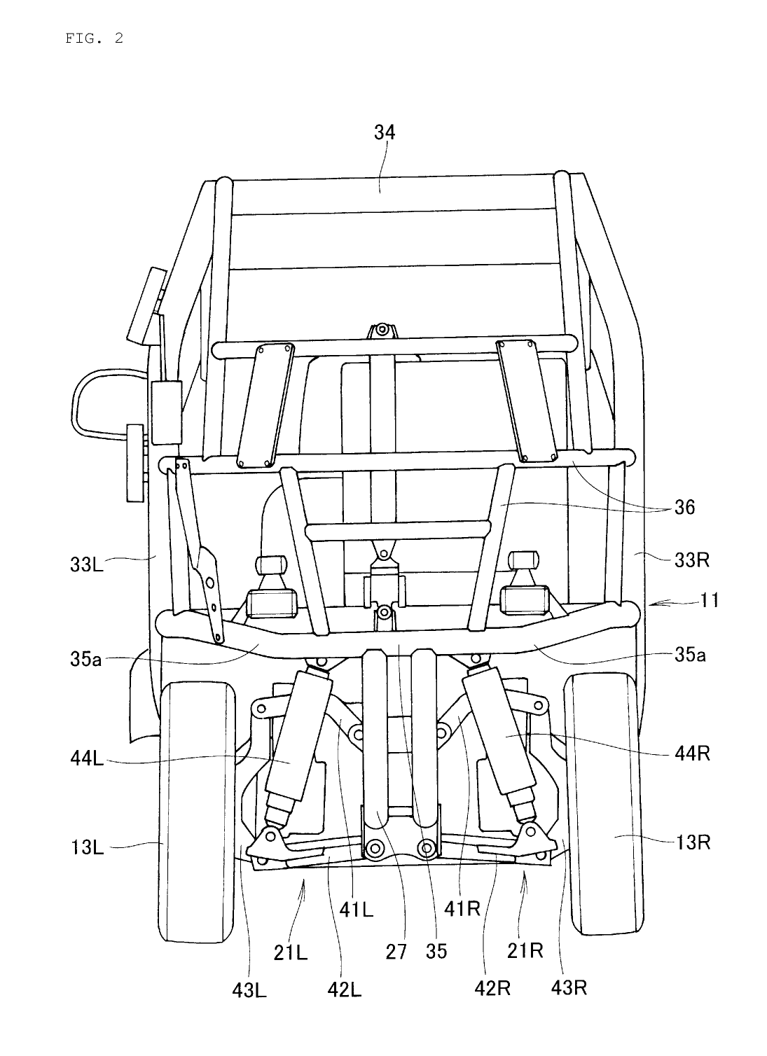

As shown in FIG. 2, the rear wheels 13L, 13R which are left and right drive wheels are supported by the suspension devices 21L, 21R to be vertically swingable on the vehicle body frame 11. Rear wheels 13L, 13R are each inclined in such a way that an upper end thereof is closer to the vehicle width center than a lower end thereof is.

The rear subframe 35 extending in a vehicle width direction is bent upward in portions over the rear wheels 13L, 13R. Providing bent portions 35a, 35b can secure spaces for upward swing of the rear wheels 13L, 13R.

The left suspension device 21L includes an upper arm 41L and a lower arm 42L which extend to the left from the vehicle body frame 11 in the vehicle width direction, a knuckle 43L which is connected to distal ends of the arms 41L, 42L, and a rear cushion 44L which is laid between the end of the lower arm 42L and the vehicle body frame 11 and cushions vertical movements of the rear wheels 13L, 13R.

In the right suspension device 21R, the suffixes of the reference numerals are changed from L to R and detailed description of the right suspension device 21R is omitted.

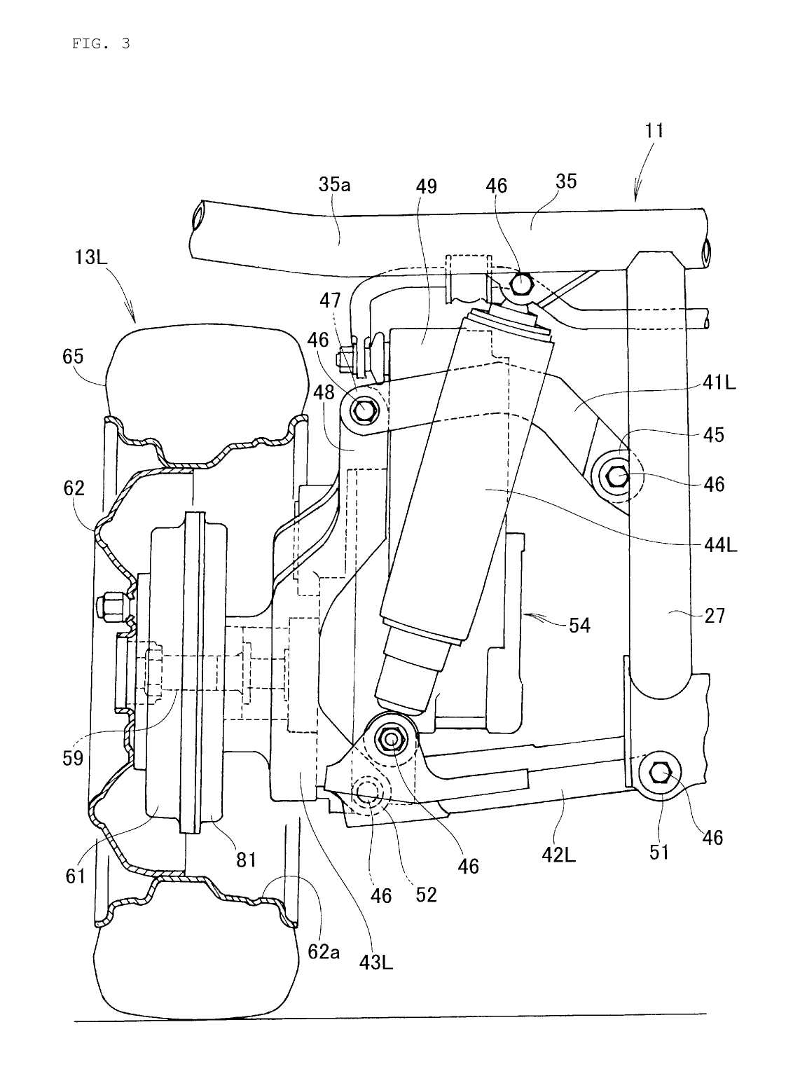

As shown in FIG. 3, the upper arm 41L is connected to the vehicle body frame 11 (specifically, the rear portion subframe 27) at a vehicle body frame side connection portion 45 with a connector 46. A bolt formed by providing a bolt head and a female screw on a pin extending in a near-far direction of the drawing is preferable as the connector 46.

The distal end of the upper arm 41L is connected to an upper arm portion 48 of the knuckle 43L at a joint portion 47 with the connector 46.

The upper arm 41L is a V-shaped member having an intermediate portion (center portion in the vehicle width direction) protruding upward. The vehicle body frame side connection portion 45 is below the joint portion 47.

A motor case 49 is disposed on the far side (vehicle front side) of the upper arm 41L in the drawing. Forming the upper arm 41L in a so-called “inverted-V shape” allows the upper arm 41L to avoid the motor case 49.

The lower arm 42L is also connected to a lower portion of the vehicle body frame 11 (specifically, the rear portion subframe 27) at a lower vehicle body frame side connection portion 51 with the connector 46 and is connected to a lower portion of the knuckle 43L at a lower joint portion 52 with the connector 46.

The rear cushion 44L is disposed in an oblique vertical direction. An upper portion of the rear cushion 44L is connected to the vehicle body frame 11 (specifically, the rear subframe 35) with the connector 46 while the lower portion thereof is connected to the lower arm 42L with the connector 46.

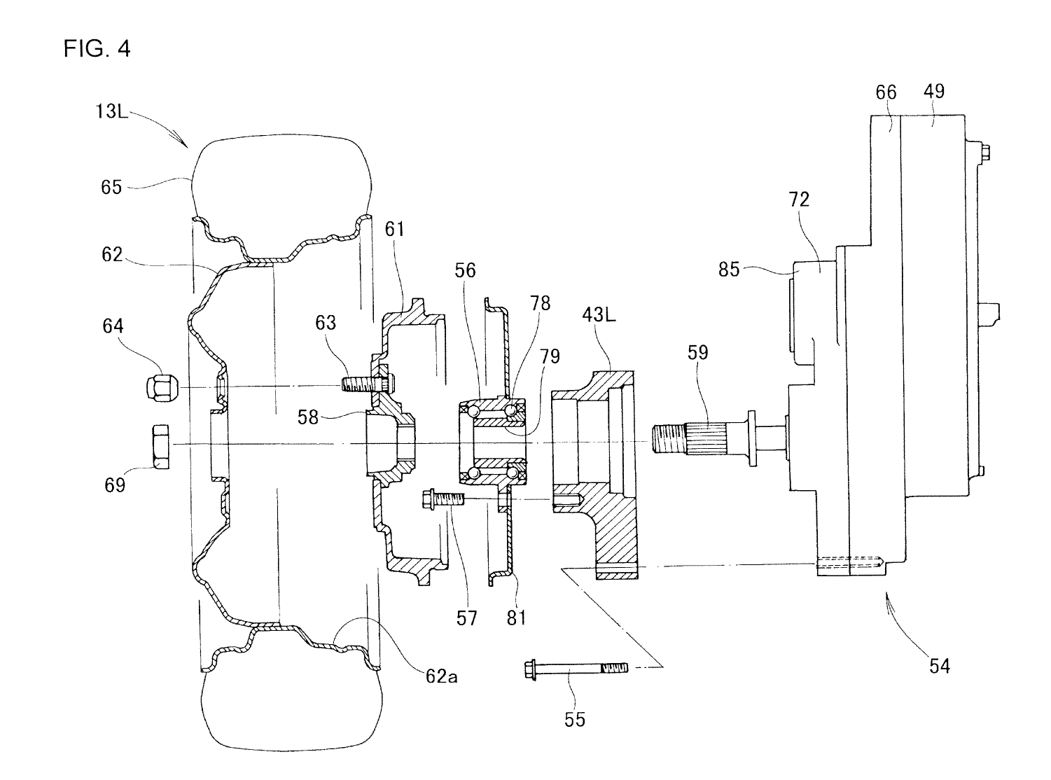

The rear wheel 13L and a drive unit 54 are attached to the knuckle 43L in such a way that the knuckle 43L is interposed between the rear wheel 13L and the drive unit 54 (details will be described in FIG. 4). The drive unit 54 serves the role of driving the rear wheel 13L.

As shown in FIG. 4, the drive unit 54 is fixed to a surface of the knuckle 43L on the vehicle body center side with a bolt 55. Moreover, a bearing case 56 is fixed to a surface of the knuckle 43L on a vehicle outer side (side of wheel 62) with a bolt 57. A wheel supporting member 58 is disposed on the vehicle outer side of the bearing case 56. The wheel supporting member 58 is spline-coupled to an output shaft 59 extending from the drive unit 54 and is rotated by the output shaft 59.

A brake drum 61 and a wheel 62 of the rear wheel 13L are fastened together to the wheel supporting member 58 with a bolt 63 and a nut 64. The rear wheel 13L and the drive unit 54 are thus attached to the knuckle 43L.

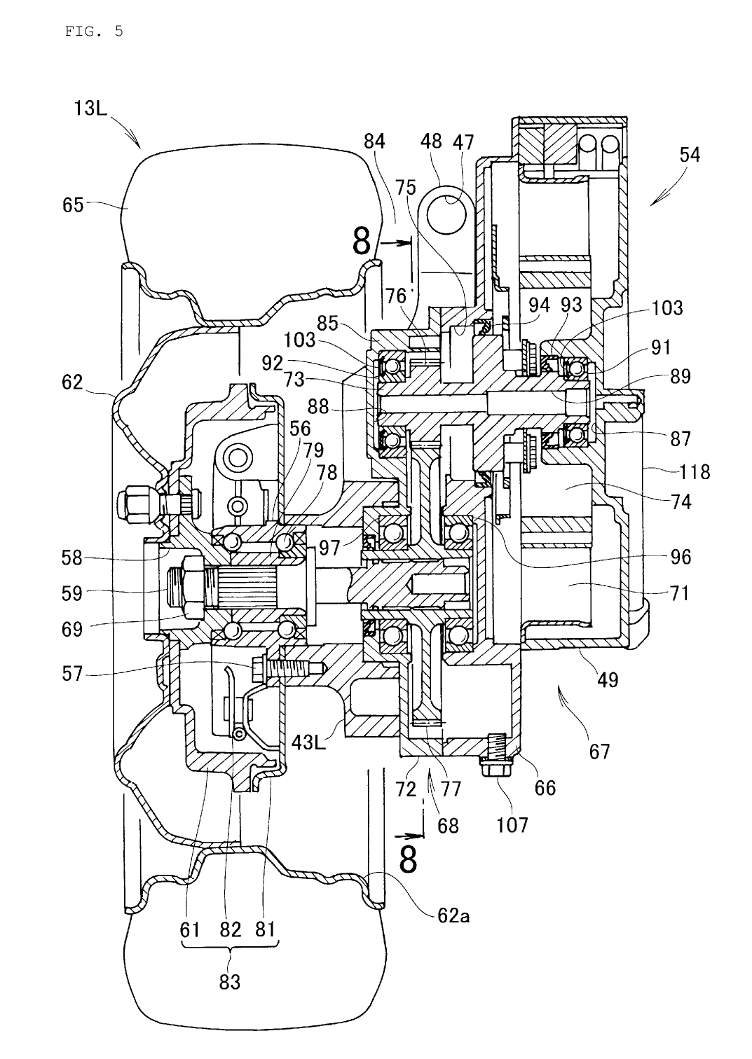

A form after the attachment is described in detail by using FIG. 5.

As shown in FIG. 5, the rear wheel 13L includes the wheel 62 which has a bowl-shaped recessed portion 62a and a tire 65 which is mounted on the wheel 62.

Moreover, the drive unit 54 is formed by attaching an electric motor 67 on one surface of a center case 66 and by attaching a reducer 68 on the other surface of the center case 66.

The electric motor 67 includes the bottomed-tube-shaped motor case 49 fastened to the center case 66, a stator 71 attached to the motor case 49, a motor shaft 73 rotatably supported at one end by the motor case 49 and rotatably supported at the other end by a reducer case 72, and a rotor 74 attached to the motor shaft 73 and surrounded by the stator 71.

The center case 66 is a vertically-long member and has a through hole 75 through which the motor shaft 73 penetrates.

The reducer 68 includes the bottomed-tube-shaped reducer case 72 fastened to the center case 66, a small-diameter drive gear 76 provided at a front end of the motor shaft 73 and housed in the reducer case 72, a large-diameter driven gear 77 rotated by the drive gear 76 directly or via an intermediate gear and housed in the reducer case 72, and the output shaft 59 rotated by the driven gear 77 and configured to rotate the wheel 62.

An inner race 79 is provided inside the bearing case 56 with rolling elements 78 therebetween, and the output shaft 59 is spline-coupled to the inner race 79. Specifically, a front end of the output shaft 59 is rotatably supported by the bearing case 56 and displacement (deflection) in a radial direction is thereby prevented.

Moreover, the wheel supporting member 58 is fixed to the front end of the output shaft 59 with a nut 69. The wheel 62 is thereby rotated by the output shaft 59. An upward load acting on the rear wheel 13L is transmitted to the wheel supporting member 58, the output shaft 59, and the inner race 79 in this order. Since the wheel supporting member 58 and the inner race 79 are in contact with each other in an axial direction and a protruding length of the output shaft 59 from the inner race 79 is short, the upward load acting on the rear wheel 13L is supported by the inner race 79 and is then supported by the knuckle 43L via the bearing case 56.

Since almost no bending moment acts on the output shaft 59, the output shaft 59 can be designed exclusively for rotary power transmission. Accordingly, the diameter of the output shaft 59 can be reduced.

A brake base plate 81 is fixed to an outer periphery of the bearing case 56. Brake shoes and a shoe expanding part 82 are attached to the brake base plate 81.

Moreover, the brake drum 61 is fixed to the wheel supporting member 58. Braking of the rear wheel 13L can be performed by causing the brake shoes to slide in contact with an inner peripheral surface of the brake drum 61.

A brake device 83 including the brake drum 61, the brake base plate 81, the brake shoes, and the shoe expanding part 82 which are described above is provided in the recessed portion 62a of the wheel 62.

Moreover, in a rear view (likewise in a vehicle front view), there is formed a rectangular space 84 surrounded from three sides by the tire 65, the reducer case 72, and the center case 66. The joint portion 47 for connecting the upper arm portion 48 and the upper arm (FIG. 3, reference numeral 41L) to each other is disposed in the rectangular space 84.

Since the joint portion 47 is disposed in the rectangular space 84, connection work and separation work of the joint portion 47 can be performed easily by using the rectangular space 84 as a work space. Accordingly, the work time can be reduced.

Moreover, a bearing supporting portion 85 supporting the other end of the motor shaft 73 is provided in the reducer case 72. The bearing supporting portion 85 protrudes to the recessed portion 62a while extending at a lateral side of the knuckle 43L.

In other words, the reducer case 72 being part of the drive unit 54 is partially housed in the recessed portion 62a of the wheel 62. The drive unit 54 can be located closer to the rear wheel (drive wheel) 13L by an amount corresponding to the housed portion. Accordingly, it is possible to dispose part of the drive unit 54 inside the wheel 62 and thereby suppress protruding of the drive unit 54 to a small degree.

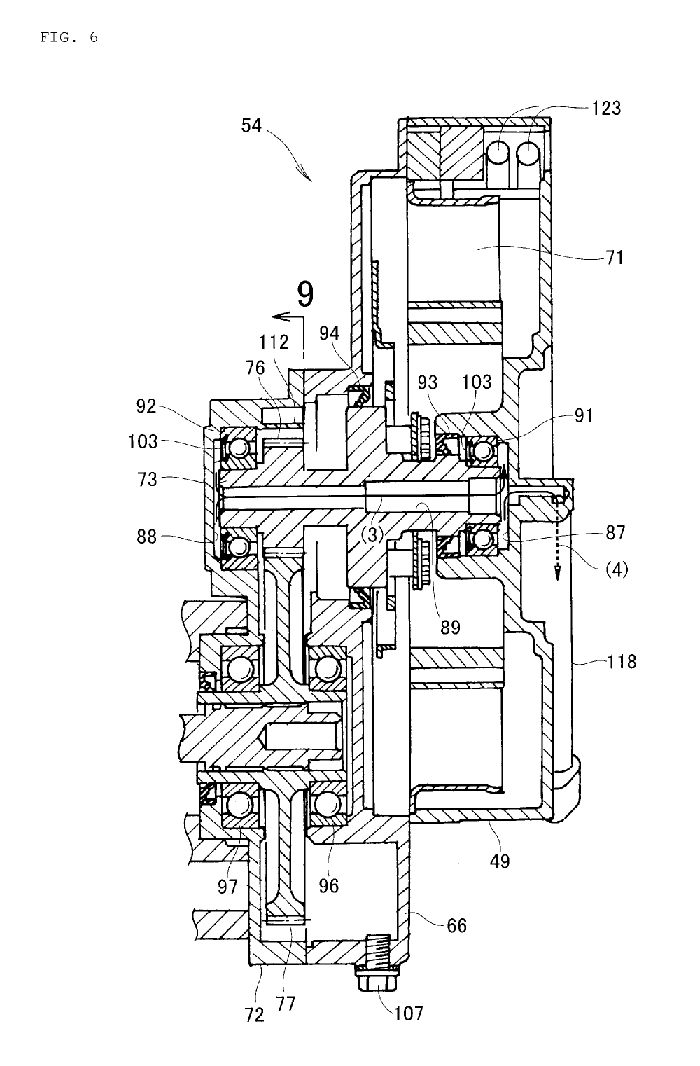

A cross section of a main portion of the drive unit 54 is described by using FIG. 6.

As shown in FIG. 6, a first oil pocket portion 87 in which oil is reserved is provided between one end of the motor shaft 73 and the motor case 49 while a second oil pocket portion 88 in which oil is reserved is provided between the other end of the motor shaft 73 and the reducer case 72. An in-motor-shaft oil passage 89 through which oil reserved in the second oil pocket portion 88 flows to the first oil pocket portion 87 is provided in the motor shaft 73.

The one end of the motor shaft 73 is supported by the motor case 49 via a first bearing 91 while the other end is supported by the reducer case 72 via a second bearing 92. A first sealing member 93 such as an oil seal is fitted between the motor shaft 73 and the motor case 49 in a portion which is closer to the second bearing 92 than the first bearing 91 is. Moreover, a second sealing member 94 is fitted between the motor shaft 73 and the center case 66 in a portion which is closer to the second bearing 92 than the first sealing member 93 is.

A space inside the electric motor and a space inside the reducer are partitioned by the second sealing member 94.

Moreover, one end of the driven gear 77 is supported by the center case 66 via a third bearing 96 while the other end is supported by the reducer case 72 via a fourth bearing 97.

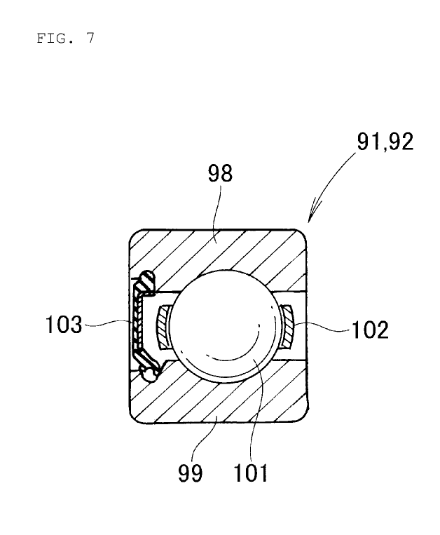

As shown in FIG. 7, the first bearing 91 and the second bearing 92 are each a single seal bearing including an outer race 98, an inner race 99, rolling bodies 101 formed of balls or rollers, a retainer 102 for aligning the multiple rolling bodies 101 at a regular pitch, and a sealing member 103 sealing one side of the rolling bodies 101. The sealing member 103 prevents oil from leaking from the bearing 91, 92 to one side (left side in the drawing).

As shown in FIG. 6, the first bearing 91 is disposed in such a way that the sealing member 103 is disposed on the side closer to the second bearing 92 while the second bearing 92 is disposed in such a way that the sealing member 103 is disposed on the side closer to the second oil pocket portion 88.

The oil reserved in the first oil pocket portion is blocked by the sealing member 103 of the first bearing 91, and the first bearing 91 is thereby lubricated. Since there is the first sealing member 93 on the side of the first bearing 91 which is closer to the second bearing 92, the sealing member 103 of the first bearing 91 can be omitted. However, when the first bearing 91 has no sealing member 103, the oil reserved in the first oil pocket portion 87 reaches the first sealing member 93. Accordingly, the level of the oil reserved in the first oil pocket portion 87 may drop. On the contrary, when the sealing member 103 is provided in the first bearing 91 to block the oil, it is possible to raise the level of the oil reserved in the first oil pocket portion 87 and thereby promote the lubrication of the first bearing 91.

The sealing member 103 of the second bearing 92 serves a role of separating the second oil pocket portion 88 and the second bearing 92 from each other. In other words, the sealing member 103 of the second bearing 92 has such an effect that the level of the oil reserved in the second oil pocket portion 88 is raised. Moreover, the sealing member 103 has such an effect that the second bearing 92 is filled with oil thrown up by the driven gear 77 and the drive gear 76.

In addition, the first bearing 91 and the second bearing 92 are each the single seal bearing including (incorporating) the sealing member 103. Similar effects can be obtained also when an oil seal is attached beside the first bearing 91 and an oil seal is disposed beside the second bearing 92. However, this increases the number of parts and increases the dimension in the axial direction. Hence, a compact design cannot be achieved.

In this respect, embodiments of the present invention use the single seal bearings in which the sealing members 103 are incorporated in the bearings. Accordingly, it is possible to reduce the number of parts and also to reduce the dimension in the axial direction.

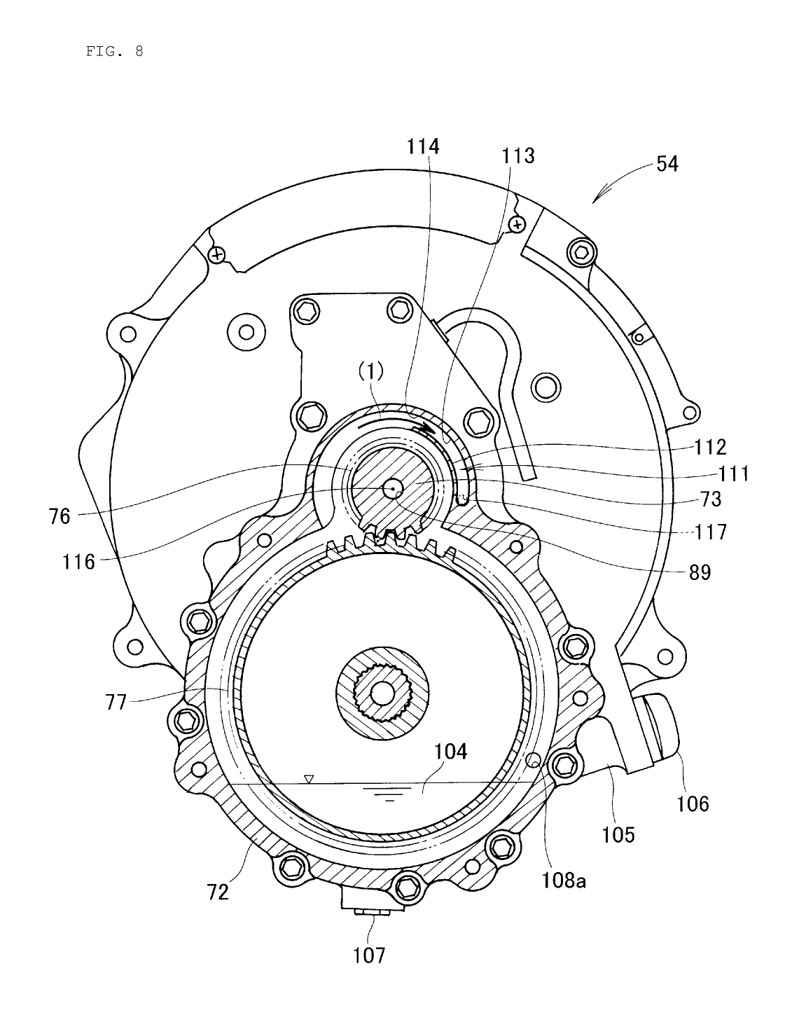

As shown in FIG. 8 which is a cross-sectional view taken along the line 8-8 of FIG. 5, a predetermined amount of oil 104 is reserved in a lower portion of the reducer case 72. The oil 104 is supplied from an oil filler 105. It is preferable that a cap 106 with a gauge is attached to the oil filler 105 and the level of the oil 104 is monitored with the gauge.

As shown in FIG. 5, the oil filler 105 is provided in the center case 66 because the center case 66 has a larger width than the reducer case 72. A drain plug 107 used for draining is also provided in the center case 66 due to the same reason. However, there is no problem in providing both or one of the oil filler 105 and the drain plug 107 in the reducer case 72.

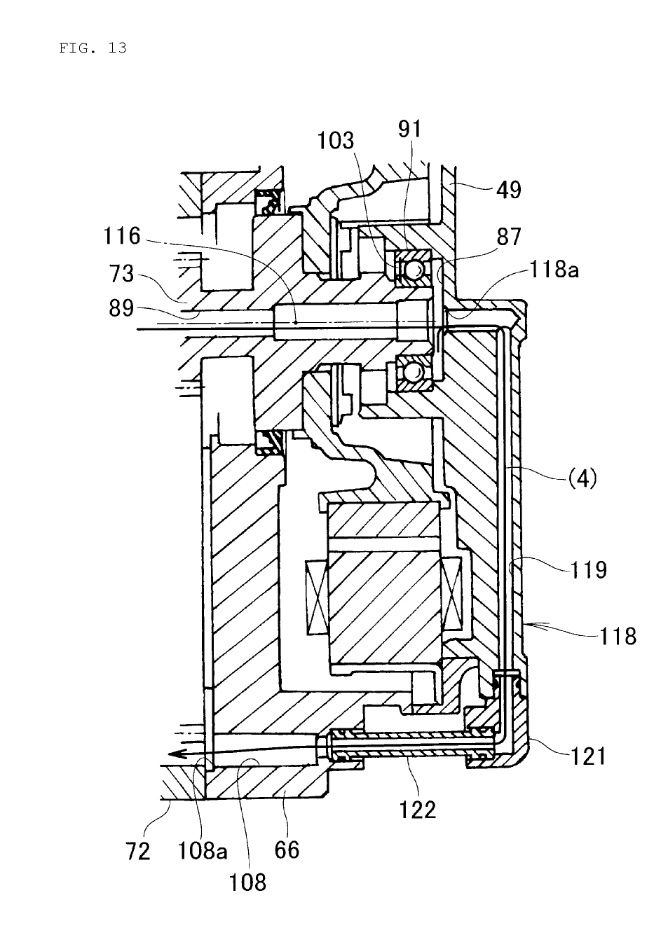

As shown in FIG. 8, an outlet 108a of a return oil passage (reference numeral 108 in FIG. 13) is opened slightly above an oil surface of the oil 104. Moreover, an oil receiving portion 111 is provided along the small-diameter drive gear 76.

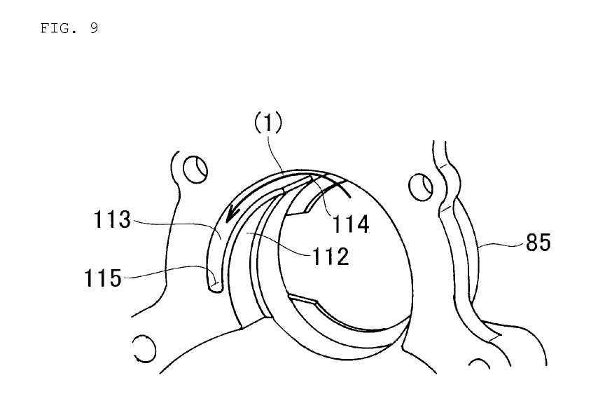

As shown in FIG. 9, the oil receiving portion 111 is an arc groove 113 formed by an arc wall 112 which stands in the reducer case 72 to surround the drive gear (reference numeral 76 in FIG. 8). An upper portion of the arc groove 113 is opened in an opening portion 114 and a lower portion 115 thereof is closed.

As shown in FIG. 8, the opening portion 114 is provided above a rotation center 116 of the motor shaft 73. A greater head (hydraulic head) can be obtained by providing the opening portion 114 at a higher position.

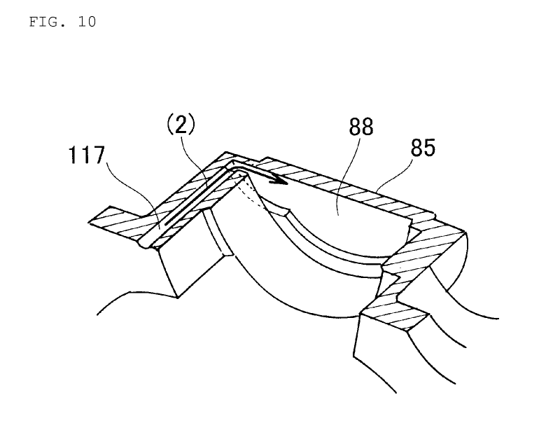

As shown in FIG. 10, a communication hole 117 is opened from the lower portion 115 of the arc groove 113, in parallel with the motor shaft 73, and a front end of the communication hole 117 is connected to the second oil pocket portion 88.

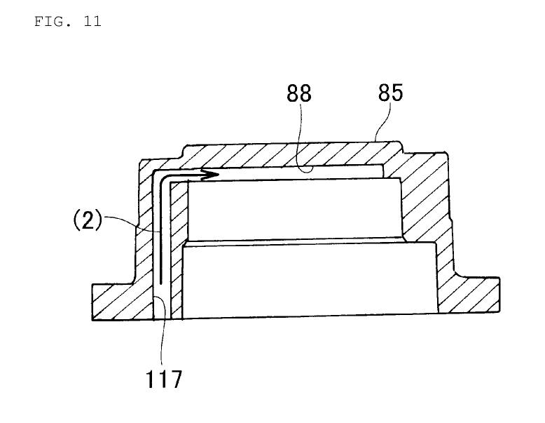

In short, as shown in FIG. 11, the front end of the communication hole 117 is connected to the second oil pocket portion 88.

As shown in FIG. 8 by an imaginary line, the communication hole 117 is provided below the rotation center 116 of the motor shaft 73. Since the communication hole 117 is provided below the rotation center 116, the oil reserved in the oil receiving portion 111 can smoothly flow to the second oil pocket portion (reference numeral 88 in FIG. 10) via the communication hole 117 by the effect of gravity.

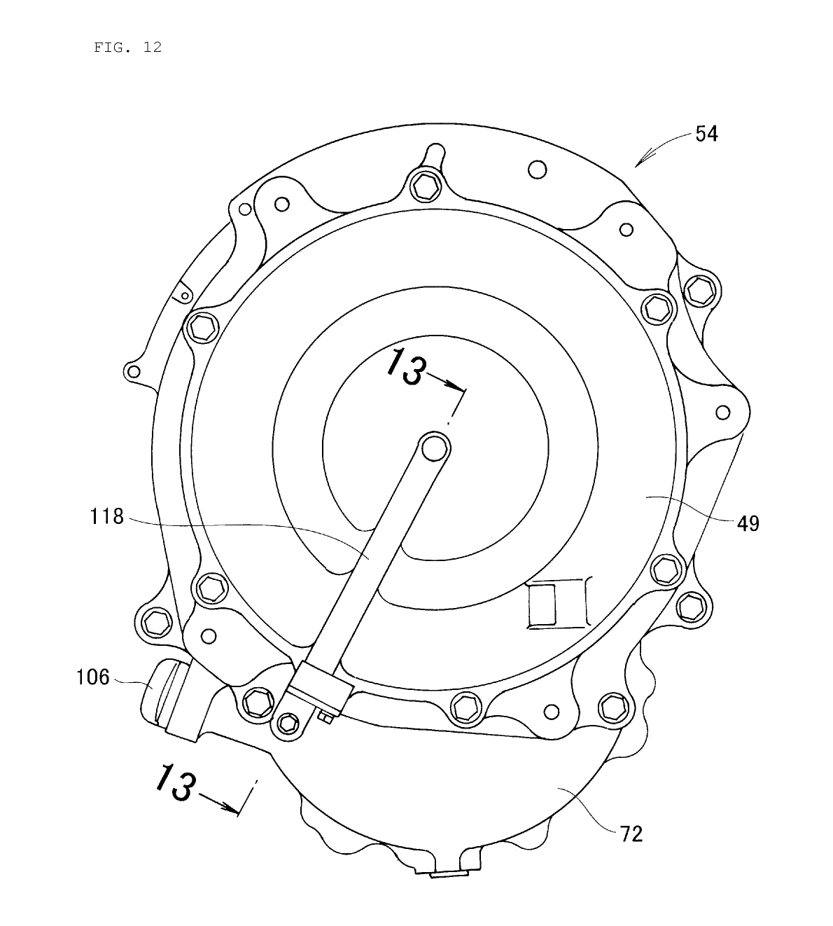

As shown in FIG. 12 which is a back surface view of the drive unit 54, a discharged oil passage 118 is provided in a back surface of the motor case 49.

As shown in FIG. 13 which is a cross-sectional view taken along the line 13-13 of FIG. 12, the discharged oil passage 118 is a passage for discharging oil from the first oil pocket portion 87 and includes an in-case oil passage 119 provided in the motor case 49, a 90° elbow 121 connected to an outlet of the in-case oil passage 119, and a connection tube 122 connecting an outlet of the 90° elbow 121 and the center case 66.

The return oil passage 108 is almost horizontally provided in the center case 66.

The 90° elbow 121 is a plug-in fitting and both ends of the connection tube 122 are also plug-in ends. In this example, the in-case oil passage 119 and the return oil passage 108 are attachably and detachably connected, unlike the case where the entire discharged oil passage 118 and the entire return oil passage 108 are formed in the motor case 49 and the center case 66. Hence, formation of the discharged oil passage 118 is facilitated.

In these embodiments, an inlet 118a of the discharged oil passage 118 is at a height almost equal to that of the rotation center 116 of the motor shaft 73.

Since the inlet 118a of the discharged oil passage 118 is at a low height, the oil reserved in the first oil pocket portion 87 can be efficiently discharged to the discharged oil passage 118. In consideration of the discharge of oil, it is preferable that the inlet 118a of the discharged oil passage 118 is provided at a height equal to or lower than that of the rotation center 116 of the motor shaft 73.

Moreover, the return oil passage 108 is disposed at a height almost equal to that of a bottom surface of the motor case 49. As shown in FIG. 6, a bottom surface of the center case 66 and a bottom surface of the reducer case 72 are disposed below the bottom surface of the motor case 49.

In FIG. 13, the return oil passage 108 is at the height almost equal to that of the bottom surface of the motor case 49. Accordingly, the discharged oil passage 118 can be extended to the bottom surface of the motor case 49. Specifically, the discharged oil passage 118 extends from a portion near the rotation center 116 of the motor shaft 73 to the bottom surface of the motor case 49. Hence, the height dimension of the discharged oil passage 118 can be increased. The so-called head (hydraulic head) is thereby increased and the oil inside the discharged oil passage 118 can efficiently flow down and quickly return into the reducer case 72.

Next, description is given of the flow of oil in the drive unit 54 having the configuration described above.

In FIG. 8, the oil 104 is held in the reducer case 72 in such a way that part of the driven gear 77 is immersed in the oil 104. The oil 104 is thrown up by the rotating driven gear 77 and the rotating drive gear 76.

The oil receiving part 111 receives part of the thrown-up oil as shown by the arrow (1).

Moreover, the rest of the thrown-up oil is used to lubricate the second bearing 92, the third bearing 96, and the fourth bearing 97 shown in FIG. 6. Thereafter, the oil drops and returns to the lower portion of the reducer case 72.

The oil received by the oil receiving portion 111 is supplied to the second oil pocket portion 88 via the communication hole 117 as shown by the arrow (2) in FIGS. 10 and 11.

In FIG. 6, the oil is supplied from the second oil pocket portion 88 to the first oil pocket portion 87 through the in-motor-shaft oil passage 89 as shown by the arrow (3). The first bearing 91 is lubricated with the oil reserved in the first oil pocket portion 87.

In FIG. 13, the oil which is reserved in the first oil pocket portion 87 and which lubricates the first bearing 91 returns to the lower portion of the reducer case 72 through the discharged oil passage 118 and the return oil passage 108 as shown by the arrow (4).

In FIG. 6, the oil flows through the in-motor-shaft oil passage 89 as shown by the arrow (3). Accordingly, the oil does not leak into the motor case 49. In other words, the inside of the motor case 49 is so-called dry. Although wires 123 extending from the stator 71 penetrate the motor case 49 and extend to the outside, no sealing measures are required in this penetrating portion. A seal in the penetrating portion may be a simple one such as a dust seal. In other words, the present invention provides a drive unit in which the sealing structure for the motor can be simplified.

The drive unit of the present invention is suitable for an electric vehicle.

### Explanation of the Reference Numerals

49 MOTOR CASE
54 DRIVE UNIT
59 OUTPUT SHAFT
66 CENTER CASE
71 STATOR
72 REDUCER CASE
73 MOTOR SHAFT
74 ROTOR
76 DRIVE GEAR
77 DRIVEN GEAR
87 FIRST OIL POCKET PORTION
88 SECOND OIL POCKET PORTION
89 IN-MOTOR-SHAFT OIL PASSAGE
91 FIRST BEARING
92 SECOND BEARING
96 THIRD BEARING
97 FOURTH BEARING
98 OUTER RACE
99 INNER RACE
101 ROLLING BODY
103 SEALING MEMBER
104 OIL
105 OIL FILLER
108 RETURN OIL PASSAGE
111 OIL RECEIVING PORTION
112 ARC WALL
113 ARC GROOVE
114 OPENING PORTION
116 ROTATION CENTER
117 CONNECTION HOLE
118 DISCHARGED OIL PASSAGE

1. A drive unit, comprising:
a center case;
a motor case attached to one side surface of the center case and supporting a stator;
a reducer case attached to another side surface of the center case;
a motor shaft penetrating the center case, supporting a rotor, and having one end supported by the motor case via a first bearing and another end supported by the reducer case via a second bearing;
a drive gear provided on the motor shaft and housed in the reducer case;
a driven gear rotated by a drive force of the drive gear and having one end supported by the center case via a third bearing and another end supported by the reducer case via a fourth bearing; and
an output shaft extending from the driven gear to penetrate the reducer case, and in which a motor output is reduced in speed and then outputted from the output shaft, wherein the reducer case is configured to hold oil in such a way that part of the driven gear is immersed in the oil, a first oil pocket portion configured such that reserved oil is provided between the one end of the motor shaft and the motor case,
a second oil pocket portion configured such that reserved oil is provided between the other end of the motor shaft and the reducer case,
the first bearing and the second bearing each include a seal configured to partition a corresponding one of the pocket portions from an adjacent chamber,
the reducer case is provided with an oil receiving portion configured to receive thrown-up oil in a portion surrounding the drive gear and is also provided with a communication hole and configured such that reserved oil in the oil receiving portion flows to the second oil pocket portion,
the motor shaft is provided with an in-motor-shaft oil passage and configured such that reserved oil in the second oil pocket portion flows to the first oil pocket portion,
the motor case is provided with a discharged oil passage configured such that reserved oil in the first oil pocket portion is discharged, and wherein
the center case is provided with a return oil passage which is connected to the discharged oil passage and through which oil from the discharged oil passage is returned into the reducer case.

2. The drive unit according to claim 1, wherein
the first bearing comprising a single seal bearing including a first outer race, a first inner race, a first rolling body, and a first sealing member sealing a first space between the first outer race and the first inner race in a portion which is closer to the second bearing than the rolling body, and
wherein the second bearing comprises a single seal bearing including a second outer race, a second inner race, a second rolling body, and a second sealing member sealing a space between the second outer race and the second inner race in a portion which is closer to the second oil pocket portion than the rolling body.

3. The drive unit according to claim 2, wherein the oil receiving portion includes a pocket-shaped arc groove formed by an arc wall which stands in the reducer case to surround the drive gear, and an opening portion configured to receive oil thrown up by the drive gear in a tangential direction is formed in an upper portion of the arc groove.

4. The drive unit according to claim 3, wherein the opening portion is disposed above a rotation center of the motor shaft and the communication hole is disposed below the opening portion.

5. The drive unit according to claim 1, wherein an inlet of the discharged oil passage is provided at a height equal to or lower than that of a rotation center of the motor shaft.

6. The drive unit according to claim 1, wherein a bottom surface of the center case and a bottom surface of the reducer case are disposed below a bottom surface of the motor case and the return oil passage is disposed at a height almost equal to that of the bottom surface of the motor case.

7. The drive unit according to claim 1, wherein the center case is provided with an oil filler into which the oil is poured.

8. A drive unit for a vehicle, said drive unit comprising:
center case means for housing drive unit components therein;
motor case means for housing motor components therein, said motor case means being attached to one side surface of the center case means, said motor case means supporting stator means therein;
reducer case means attached to another side surface of the center case means, said reducer case means for housing reducer components therein;
motor shaft means for transferring rotating power, said motor shaft means penetrating the center case means, said motor shaft means supporting rotor means therein, and having one end supported by the motor case means via first bearing means and another end supported by the reducer case means via second bearing means;
drive gear means provided on the motor shaft means and housed in the reducer case means;
driven gear means for being rotated by a drive force of the drive gear means and having one end supported by the center case means via third bearing means and another end supported by the reducer case means via fourth bearing means; and
output shaft means extending from the driven gear means to penetrate the reducer case means, said output shaft means outputting a motor output which is reduced in speed,
wherein the reducer case means is for holding oil in such a way that a part of the driven gear means is immersed in the oil, wherein a first oil pocket portion is formed between the one end of the motor shaft means and the motor case means, a second oil pocket portion is formed between the other end of the motor shaft means and the reducer case means, wherein the first bearing means and the second bearing means each include seal means for partitioning a corresponding one of the first and second oil pocket portions from an adjacent chamber, wherein the reducer case means includes an oil receiving portion for receiving thrown-up oil in a portion surrounding the drive gear means and is provided with communication means for allowing oil in the oil receiving portion to flow to the second oil pocket portion, wherein the motor shaft means is provided with an in-motor-shaft oil passage means for allowing oil in the second oil pocket portion to flow to the first oil pocket portion, wherein the motor case means includes discharged oil passage means for allowing oil reserved in the first oil pocket portion to be discharged, and wherein the center case means includes a return oil passage means connected to the discharged oil passage means, for allowing oil from the discharged oil passage means to be returned into the reducer case means.

9. The drive unit according to claim 8, wherein the first bearing means comprises first single seal bearing means including first outer race means, first inner race means, first rolling body means, and first sealing means, said first sealing means for sealing a first space between the first outer race means and the first inner race means in a portion which is closer to the second bearing means than the first rolling body means, and
wherein the second bearing means comprises second seal bearing means including second outer race means, second inner race means, second rolling body means, and second sealing means, said second sealing means for sealing a space between the second outer race means and the second inner race means in a portion which is closer to the second oil pocket portion than the second rolling body means.

10. The drive unit according to claim 9, wherein the oil receiving portion includes a pocket-shaped arc groove formed by an arc wall which stands in the reducer case to surround the drive gear, and an opening portion configured to receive oil thrown up by the drive gear means in a tangential direction is formed in an upper portion of the arc groove.

11. The drive unit according to claim 10, wherein the opening portion is disposed above a rotation center of the motor shaft means, and wherein the communication hole is disposed below the opening portion.

12. The drive unit according to claim 8, wherein the discharged oil passage means comprises inlet means for enabling oil to flow therethrough, said inlet means being disposed at a height which is equal to or lower than a height of a rotation center of the motor shaft means.

13. The drive unit according to claim 8, wherein a bottom surface of the center case means and a bottom surface of the reducer case means are disposed below a bottom surface of the motor case means, and wherein the return oil passage means is disposed at a height which is almost equal to a height of the bottom surface of the motor case means.

14. The drive unit according to claim 8, wherein the center case means comprises an oil filler means for receiving poured oil therein.
